(19) United States
(12) Patent Application Publication
(10) Pub. No.: US 2008/0070085 A1
(43) Pub. Date: Mar. 20, 2008

(54) Sulfonated Polymer Comprising Nitrile-Type Hydrophobic Block And Solid Polymer Electrolyte

(76) Inventors: Nagayuki Kanaoka, Saitama (JP); Masaru Iguchi, Saitama (JP); Hiroshi Sohma, Saitama (JP)

Correspondence Address: ARENT FOX LLP, 1050 CONNECTICUT AVENUE, N.W., SUITE 400, WASHINGTON, DC, 20036, US

(21) Appl. No.: 11/596,648

(22) PCT Filed: Nov. 1, 2004
(86) PCT No.: PCT/JP04/16501

§ 371 Date: Nov. 16, 2006

(51) Int. Cl. H01M 8/10

(52) U.S. Cl. 429/33

(57) ABSTRACT

A membrane-electrode assembly for a solid polymer electrolyte fuel cell having excellent hot water resistance, oxidation resistance and low temperature size stability and exhibiting excellent power generation performance even under low temperature environment. The membrane-electrode assembly is equipped with a polymer electrolyte membrane composed of a sulfonated polyarylene polymer having a recurring unit of the formula (1) and a recurring unit of the formula (2):

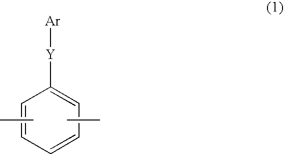

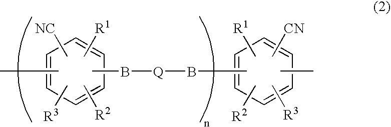

### TECHNICAL FIELD

The present invention relates to a nitrile-containing compound, a sulfonated polymer containing a recurring unit introduced from the compound, and a solid polymer electrolyte composed of the sulfonated polymer.

### BACKGROUND ART

Environmental problems such as global warming are becoming more serious owing to consumption of fossil fuels, while oil resources are being depleted. Fuel cells have therefore attracted attention as clean power sources for motors which release no carbon dioxide, and have been extensively developed. In some fields, their commercialization has been started. When the fuel cell is mounted in an automobile or the like, a solid polymer electrolyte fuel cell using a polymer electrolyte membrane is suitably used because it can produce a high voltage and large electric current.

As membrane-electrode assembly to be used for the solid polymer electrolyte fuel cell, known are those comprising a pair of electrode catalyst layers formed by integrating, by an ion conductive polymer binder, a catalyst such as platinum supported by a catalyst carrier such as carbon black, an ion-conductive polymer electrolyte membrane inserted between these electrode catalyst layers, and a diffusion layer stacked over each of the electrode catalyst layers (refer to, for example, Japanese Patent Laid-Open No. 2000-223136). The membrane-electrode assembly constitutes a solid polymer electrolyte fuel cell with a separator, which also serves as a gas passage, stacked over each of the electrode catalyst layers.

In the solid polymer electrolyte fuel cell, a reducing gas such as hydrogen or methanol is introduced via the diffusion layer into one of the electrode catalyst layers serving as a fuel electrode, and an oxidizing gas such as air or oxygen is introduced also via the diffusion layer into the other electrode catalyst layer serving as the oxygen electrode. By such a structure, proton is produced from the reducing gas on the fuel electrode side by the action of the catalyst contained in the electrode catalyst layer. The proton thus formed transfers to the electrode catalyst layer on the oxygen electrode side via the polymer electrolyte membrane. By the action of the catalyst contained in the electrode catalyst layer, the proton then reacts with the oxidizing gas introduced into the oxygen electrode to produce water in the electrode catalyst layer on the oxygen electrode side. A current can therefore be produced by connecting the fuel electrode and oxygen electrode to each other by a conductor.

Conventionally, in the membrane-electrode assembly, perfluoroalkylenesulfonic acid polymer compounds (such as “Nation”, trade mark; product of Dupont) have been widely used as the polymer electrolyte membrane. Although the perfluoroalkylenesulfonic acid polymer compounds exhibit excellent proton conductivity because they are sulfonated and in addition have chemical resistance as a fluorine-based resin, they are very expensive.

Thus, use of an inexpensive ion conductive material instead of the perfluoroalkylenesulfonic polymer compound for the formation of the membrane-electrode assembly has therefore been under investigation. A sulfonated hydrocarbon polymer can be given as an example of the inexpensive ion conductive material. The sulfonated hydrocarbon polymer has advantages such as resistance to crossleak owing to high gas barrier properties and excellent shape stability due to high creep resistance.

However, the polymer electrolyte membrane composed of the hydrocarbon polymer tends to deteriorate when exposed to hot water or an acid and thus has low hot water resistance and oxidation resistance. In addition to these inconveniences, the polymer electrolyte membrane composed of the hydrocarbon polymer shrinks greatly at low temperatures so that when a membrane-electrode assembly is prepared using it, peeling of the electrode tends to occur under low temperature environments; and a solid polymer electrolyte fuel cell prepared using it cannot exhibit sufficient power generation performance under low temperature environments and moreover, tends to have lowered power production capacity.

### DISCLOSURE OF THE INVENTION

An object of the present invention is to overcome the above-described inconveniences; and provide a membrane-electrode assembly excellent in hot water resistance, oxidation resistance and size stability at low temperatures and capable of providing excellent power generation performance even under low temperature environments, and a solid polymer electrolyte fuel cell using the membrane-electrode assembly.

With a view to attaining such an object, the present invention is characterized in that a membrane-electrode assembly for a solid polymer electrolyte fuel cell comprising a pair of electrode catalyst layers containing a catalyst; and a polymer electrolyte membrane inserted between the two electrode catalyst layers, the polymer electrolyte membrane comprises a sulfonated polyarylene polymer having a first recurring unit represented by the formula (1) and a second unit represented by the formula (2). 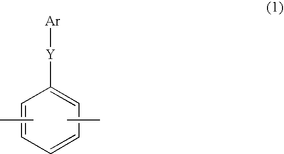
(wherein Y represents a divalent atom or organic group, or a direct bond, and Ar represents an aromatic group, with the proviso that the aromatic group includes derivatives thereof.) 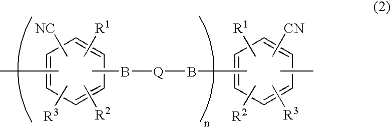
(wherein B independently represents an oxygen atom or a sulfur atom, R¹ to R³ each represents a hydrogen atom, a fluorine atom, a nitrile group or an alkyl group and they may be the same or different, n stands for an integer of 2 or greater and Q is a structure represented by the following formula (3): 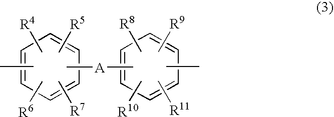
(wherein A independently represents a divalent atom or organic group, or a direct bond, and R⁴ to R¹¹ each represents a hydrogen atom, a fluorine atom, an alkyl group or an aromatic group and they may be the same or different, with the proviso that the aromatic group includes derivatives thereof)).

In the membrane-electrode assembly, the polyarylene polymer is a block copolymer containing the first recurring unit represented by the formula (1) and the second recurring unit represented by the formula (2). The sulfonated block copolymer is formed by introducing a sulfonic acid group into the aromatic group represented by Ar in the formula (1). As a result, the sulfonated first recurring unit forms a hydrophilic portion, while the un-sulfonated second recurring unit becomes a hydrophobic portion. Thus, the block copolymer is equipped with a hydrophilic portion and hydrophobic portion.

Also, the second recurring unit represented by the formula (2) contains, in the structure thereof, a nitrile (—CN) group so that it can heighten the heat resistance and acid resistance of the polyarylene polymer and in addition, it can heighten the hydrophobic property of the second recurring unit and promote phase separation between the hydrophilic portion and hydrophobic portion. Even a small amount of water can therefore efficiently give the polymer ion conductivity, whereby a percentage size change of the polyarylene polymer can be suppressed to a low level.

Therefore, according to the present invention, the membrane-electrode assembly having excellent heat resistance, acid resistance and ion conductivity can be obtained. In addition, in the membrane-electrode assembly of the present invention, excellent adhesion between the polymer electrolyte membrane and electrode catalyst layers can be attained because of a reduction in the percentage size change of the sulfonated polyarylene polymer.

In the present invention, the structure represented by the formula (3) preferably has, as the above-described A, at least one organic group selected from the class consisting of —CONH—, —(CF₂)ₚ— (in which p is an integer of from 1 to 10), —C(CF₃)₂—, —COO—, —SO—, —SO₂— and organic groups represented by the following formula (4): 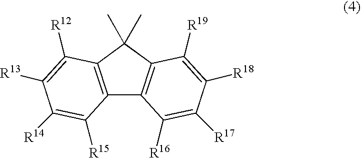
(wherein R¹² to R¹⁹ each represents a hydrogen atom, a fluorine atom, an alkyl group or an aromatic group and they may be the same or different with the proviso that the aromatic group includes derivatives thereof).

Also, the structure represented by the formula (3) may contain both a first structure in which the A is an organic group selected from the class consisting of —CONH—, —(CF₂)ₚ— (in which p is an integer of from 1 to 10), —C(CF₃)₂—, —COO—, —SO— and —SO₂— and a second structure in which the A represents a direct bond or an organic group represented by the formula (4).

In this case, when the structure represented by the formula (3) comprises from 70 to 99 mol % of the first structure and from 1 to 30 mol % of the second structure (with the proviso that the total of the first and second structures is adjusted to 100 mol %), the percentage size change of the resulting polymer can be suppressed to a lower level.

Moreover, the electrode catalyst layer preferably has carbon particles having a catalyst supported thereon and an ion conductive binder composed of a perfluoroalkylenesulfonic acid polymer compound and contains from 0.01 to 1.0 mg/cm² of platinum as the catalyst. The perfluoroalkylenesulfonic acid polymer compound serving as the ion conductive binder of the electrode catalyst layers is excellent in the affinity with the sulfonated polyarylene polymer containing a nitrile (—CN) group in the structure of the second recurring unit. Accordingly, in the membrane-electrode assembly of the present invention, since the ion conductive binder of the electrode catalyst layers is a perfluoroalkylenesulfonic acid polymer compound, stronger adhesion can be achieved between the polymer electrode membrane and electrode catalyst layers.

In addition, when the electrode catalyst layers contain, as the catalyst, platinum in an amount within the above-described range, a solid polymer electrolyte fuel cell using the membrane-electrode assembly having such electrode catalyst layers can have excellent power generation performance.

Moreover, the solid polymer electrolyte fuel cell of the present invention can exhibit excellent power generation performance even under low temperature environments and at the same time, can keep this power generation performance for a long period of time, by using a membrane-electrode assembly for solid polymer electrolyte fuel cell which includes a pair of electrode catalyst layers containing a catalyst; and a polymer electrode membrane inserted between the electrode catalyst layers, wherein said polymer electrolyte membrane being composed of a sulfonated polyarylene polymer having a first recurring unit represented by the formula (1) and a second recurring unit represented by the formula (2).

### BRIEF DESCRIPTION OF THE DRAWINGS

FIG. 1 is a schematic cross-sectional view illustrating the structure of the membrane-electrode assembly of the invention.

### BEST MODE FOR CARRYING OUT THE INVENTION

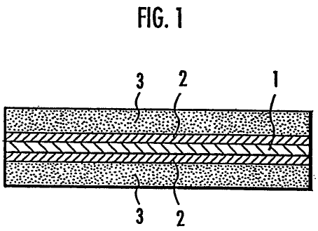

Next, embodiments of the present invention will hereinafter be described referring to accompanying drawings. FIG. 1 is a schematic cross-sectional view illustrating the structure of the membrane-electrode assembly of this Embodiment.

The membrane-electrode assembly of this Embodiment is, as illustrated in FIG. 1, composed of a solid polymer electrolyte membrane 1, a pair of electrode catalyst layers having the solid polymer electrolyte membrane 1 inserted therebetween, and gas diffusion layers 3,3 stacked over the electrode catalyst layers 2,2, respectively.

The solid polymer electrolyte membrane 1 is composed of a sulfonated polyarylene polymer having a first recurring unit represented by the following formula (1) and a second recurring unit represented by the formula (2). 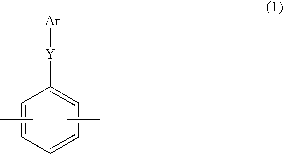
(wherein Y represents a divalent atom or organic group, or a direct bond, and Ar represents an aromatic group, with the proviso that the aromatic group includes derivatives thereof.) 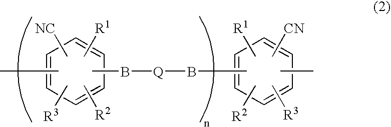
(wherein B independently represents an oxygen atom or a sulfur atom, R¹ to R³ each represents a hydrogen atom, a fluorine atom, a nitrile group or an alkyl group and they may be the same or different, n stands for an integer of 2 or greater and Q is a structure represented by the following formula (3): 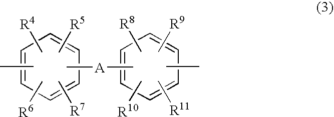
(wherein A independently represents a divalent atom or organic group, or a direct bond, and R⁴ to R¹¹ each represents a hydrogen atom, a fluorine atom, an alkyl group or an aromatic group and they may be the same or different, with the proviso that the aromatic group includes derivatives thereof)).

In the formula (1), examples of the divalent organic group represented by Y include electron withdrawing groups such as —CO—, —CONH—, —(CF₂)ₚ— (wherein, p represents an integer of from 1 to 10), —C(CF₃)₂—, —COO—, —SO— and —SO₂— and electron donating groups such as —O—, —S—, —CH═CH—, —C≡—C— and groups represented by the following formulas:

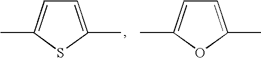

In this instance, the above-described electron withdrawing group means a group having a Hammett substituent constant of 0.06 or greater when it is at the meta position of a phenyl group and 0.01 or greater when it is in the para position of a phenyl group.

In the formula (1), Y is preferably an electron withdrawing group, because the sulfonated polyarylene polymer can have an increased acid intensity and in addition, the elimination temperature of sulfonic acid can be raised. Of the electron withdrawing groups, —CO— and —SO₂ are especially preferred.

In the formula (1), examples of the aromatic group represented by Ar include phenyl, naphthyl, pyridyl, phenoxyphenyl, phenylphenyl and naphthoxyphenyl groups. The aromatic group may have a substituent.

In the formula (2), examples of the alkyl group represented by R¹ to R³ include methyl, ethyl, propyl, butyl, amyl and hexyl groups, with methyl and ethyl groups being preferred. In the formula (2), n stands for an integer of 2 or greater and its upper limit is usually 100, preferably 80.

In the formula (3), examples of the alkyl group represented by R⁴ to R¹¹ include methyl, ethyl, propyl, butyl, amyl and hexyl groups, with methyl and ethyl groups being preferred. In the formula (3), examples of the aromatic group represented by R⁴ to R¹¹ include phenyl, naphthyl, pyridyl, phenoxydiphenyl, phenylphenyl, naphthoxyphenyl groups.

In the formula (3), examples of the divalent organic group represented by A include electron withdrawing groups such as —CO—, —CONH—, —(CF₂)ₚ— (wherein, p represents an integer of from 1 to 10), —C(CF₃) ₂—, —COO—, —SO— and —SO₂— and electron donating groups such as —O—, —S—, —CH═CH—, —C≡—C— and groups represented by the following formulas:

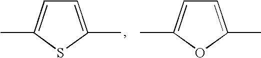

Also, in the formula (3), the electron donating group may be a group represented by the following formula (4): 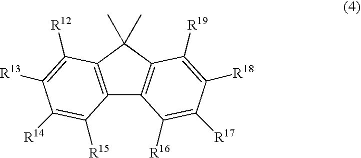
(wherein R¹² to R¹⁹ are each a hydrogen atom, a fluorine atom, an alkyl group or an aromatic group and may be the same or different, with the proviso that the aromatic group includes derivatives thereof).

In the formula (4), examples of the alkyl group represented by R¹² to R¹⁹ include methyl, ethyl, propyl, butyl, amyl and hexyl groups, with methyl and ethyl groups being preferred. In the formula (4), examples of the aromatic group represented by R¹² to R¹⁹ include phenyl, naphthyl, pyridyl, phenoxydiphenyl, phenylphenyl and naphthoxyphenyl groups.

Also, in the structure represented by the formula (3), the above-described A is preferably at least one organic group selected from the class consisting of —CONH—, —(CF₂)ₚ— (in which p is an integer of from 1 to 10), —C(CF₃)₂—, —COO—, —SO—, —SO₂— and groups represented by the above-described formula (4).

In the structure represented by the formula (3), the above-described A may contain both a first structure which is an organic group selected from the class consisting of —CONH—, —(CF₂)ₚ— (in which p is an integer of from 1 to 10), —C(CF₃)₂—, —COO—, —SO— and —SO₂—, and a second structure which is a direct bond or an organic group represented by the formula (4).

The structure represented by the formula (3) contains from 20 to 99 mol %, preferably from 30 to 95 mol %, more preferably from 35 to 90 mol % of the first structure and from 1 to 80 mol %, preferably from 5 to 70 mol %, more preferably from 10 to 65 mol % of the second structure (with the proviso that the total content of the first structure and the second structure is 100 mol %). When the contents of the first structure and the second structure fall within the above-described ranges, respectively, the percentage size change of the polyarylene polymer containing a first recurring unit represented by the formula (1) and a second recurring unit represented by the formula (2) can be suppressed to a lower level.

The above-described polyarylene polymer can be synthesized by the copolymerization reaction of a compound represented by the formula (6) and a compound represented by the formula (7) in the presence of a catalyst containing a transition metal compound.

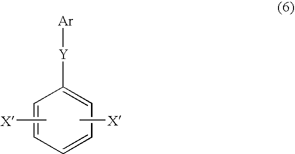

In the formula (6), Y and Ar have the same meanings as those in the formula (1) and X′ represents an atom or group selected from the class consisting of halogen atoms (chlorine, bromine and iodine) other than fluorine, —OSO₂CH₃ and —OSO₂CF₃.

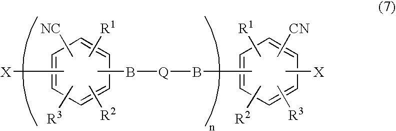

In the formula (7), B, R¹ to R³, n and Q have the same meanings as those in the formula (2) and X represents an atom or group selected from the class consisting of halogen atoms (chlorine, bromine and iodine) other than fluorine, —OSO₂CH₃ and —OSO₂CF₃.

The compound represented by the formula (7) can be synthesized by the reaction as described below.

First, a bisphenol linked via a divalent atom or organic group or a direct bond is dissolved in a polar solvent having a high dielectric constant such as N-methyl-2-pyrrolidone, N,N-dimethylacetamide, sulfolane, diphenylsulfone or dimethylsulfoxide. In order to convert it into an alkali metal salt of the resulting bisphenol, an alkali metal such as lithium, sodium or potassium, an alkali metal hydride, an alkali metal hydroxide or an alkali metal carbonate is added to the resulting solution in the polar solvent. With the hydroxyl group of the phenol, a slight excess of the alkali metal relative thereto is reacted. Its amount is usually from 1.1 to 2 times the equivalent, preferably from 1.2 to 1.5 times the equivalent. The progress of the reaction is preferably accelerated by allowing a solvent azeotropic with water such as benzene, toluene, xylene, chlorobenzene or anisole to coexist.

Then, the alkali metal salt of bisphenol is reacted with a benzonitrile compound substituted with a halogen atom such as chlorine and a nitrile group. Examples of the benzonitrile compound include 2,6-dichlorobenzonitrile, 2,6-difluorobenzonitrile, 2,5-dichlorobenzonitrile, 2,5-difluorobenzonitrile, 2,4-dichlorobenzonitrile, 2,4-difluorobenzonitrile, 2,6-dinitrobenzonitrile, 2,5-dinitrobenzonitrile and 2,4-dinitrobenzonitrile. Of these compounds, dichlorobenzonitrile compounds are preferred, with 2,6-dichlorobenzonitrile being more preferred.

The benzonitrile compound is added in an amount of from 1.0001 to 3 times the mol of bisphenol, with from 1.001 to 2 times the mol being preferred. After completion of the reaction, in order to impart a chlorine atom to both ends of the reaction product, an excess amount of, for example, 2,6-dichlorobenzonitrile may be added to effect the reaction further. When a difluorobenzonitrile compound or dinitrobenzonitrile compound is used, on the other hand, the reaction must be effected so that the reaction product has a chlorine atom at both ends thereof by utilizing a method such as addition of a dichlorobenzonitrile compound in the latter half of the reaction. In the above-described reaction, the reaction temperature is from 60 to 300° C., preferably from 80 to 250° C., while the reaction time is for from 15 minutes to 100 hours, preferably for from 1 to 24 hours.

The oligomer or polymer obtained by the above-described reaction can be purified by an ordinary method for polymer, for example, dissolution-precipitation. The molecular weight can be adjusted by controlling a reaction molar ratio between an excess amount of an aromatic dichloride and bisphenol. In the above-described reaction system, owing to the presence of an excess amount of an aromatic dichloride substituted by a nitrile group, the oligomer or polymer thus obtained has, at the molecular end thereof, an aromatic chloride substituted by a nitrile group.

Specific examples of the oligomer or polymer having, at the molecular end thereof, an aromatic chloride substituted by a nitrile group include following compounds:

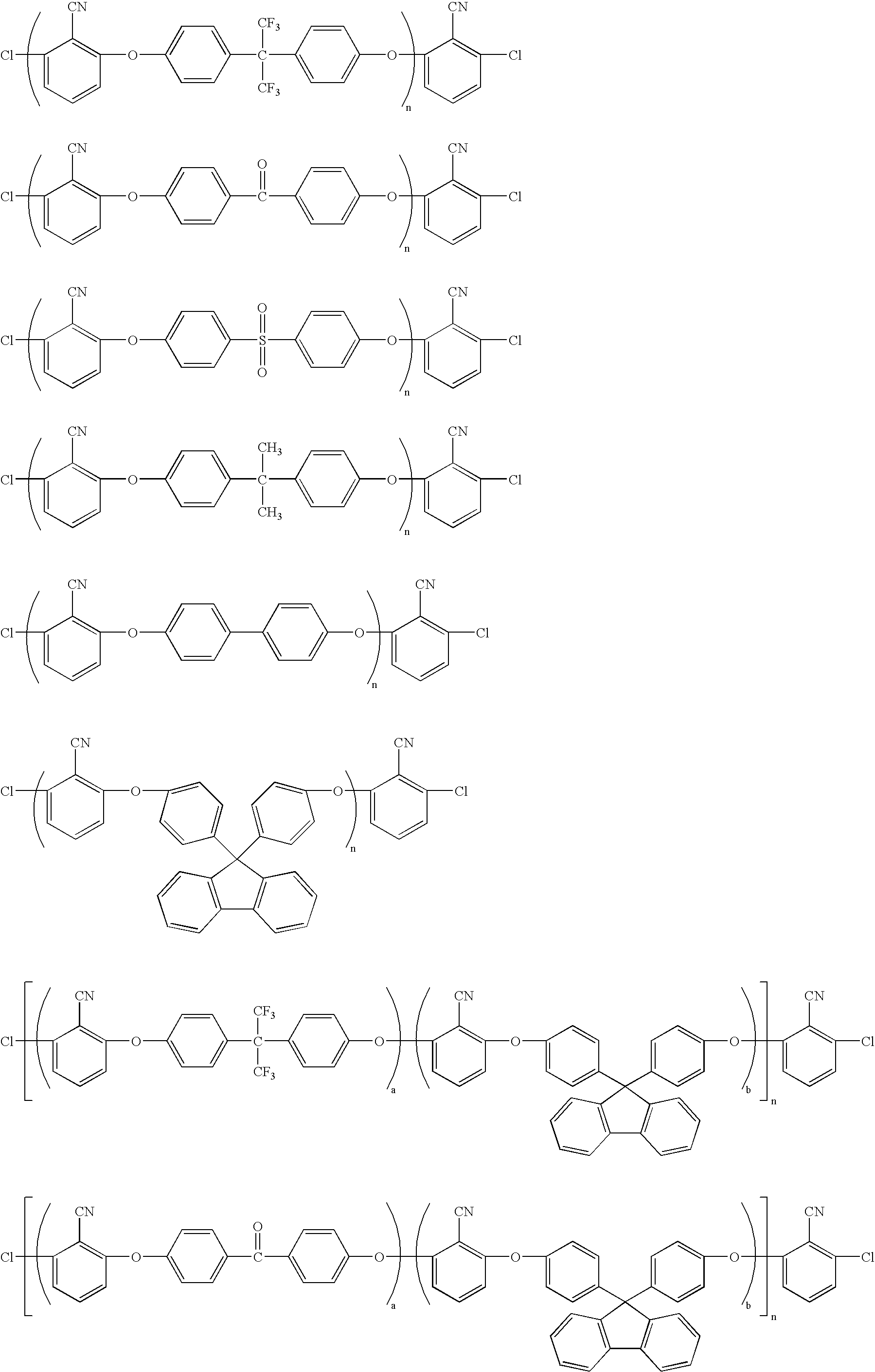

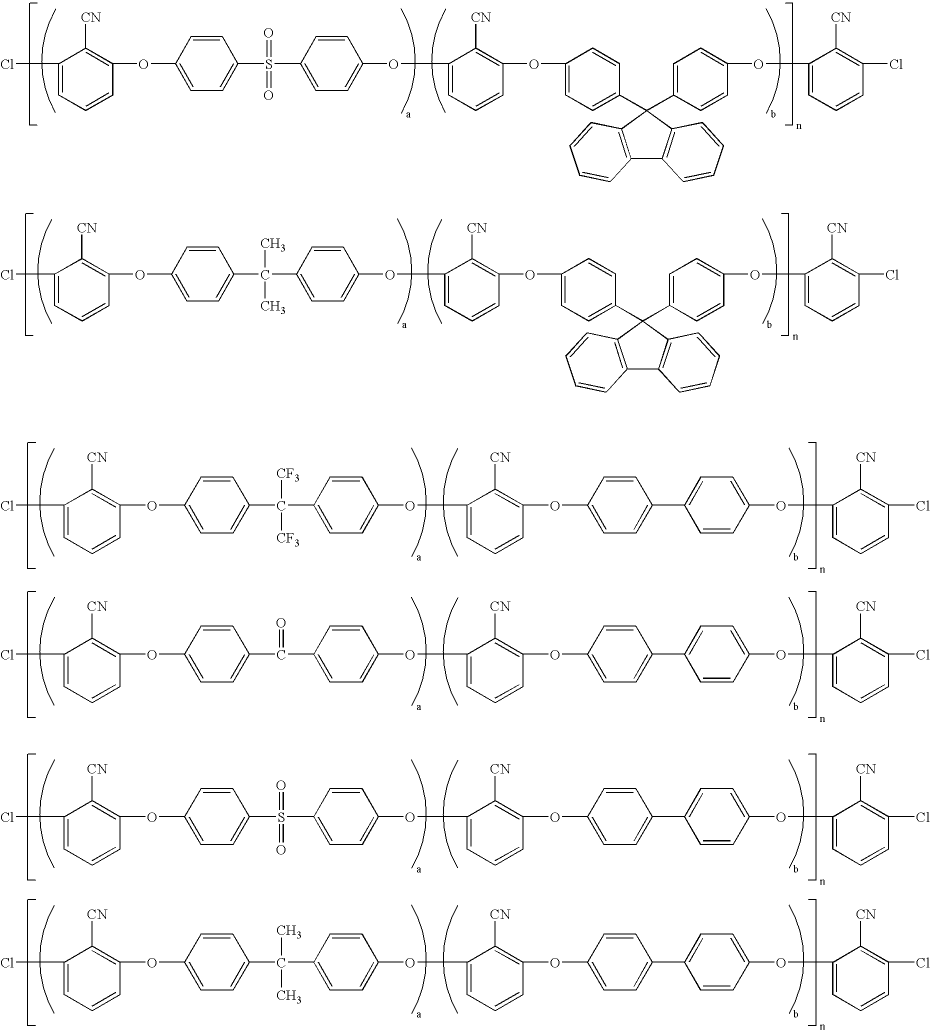

In the copolymerization reaction between the compound represented by the formula (6) and the compound represented by the formula (7), the using amount of the compound represented by the formula (6) is from 0.001 to 90 mol %, preferably from 0.1 to 80 mol % relative to the total amount, while the using amount of the compound represented by the formula (7) is from 99.999 to 10 mol %, preferably from 99.9 to 20 mol % relative to the total amount.

The catalyst to be used in the copolymerization reaction is a catalyst system containing a transition metal compound. This catalyst system has, as essential components, a transition metal salt, a compound which will be a ligand (hereinafter called “ligand component”) or a ligand-coordinated transition metal complex (including a copper salt), and a reducing agent. It may contain a salt further to raise the polymerization rate.

Here, examples of the transition metal salt includes nickel compounds such as nickel chloride, nickel bromide, nickel iodide, and nickel acetylacetonate; palladium compounds such as palladium chloride, palladium bromide, and palladium iodide; iron compounds such as ferrous chloride, ferrous bromide, and ferrous iodide; and cobalt compounds such as cobalt chloride, cobalt bromide, and cobalt iodide. Of these transition metal salts, nickel chloride and nickel bromide are especially preferred.

Also, examples of the ligand component include triphenylphosphine, 2,2′-bipyridine, 1,5-cyclooctadiene, and 1,3-bis(diphenylphosphino)propane. Of these, triphenylphosphine and 2,2′-bipyridine are preferred. The compounds serving as the ligand component may be used either singly or in combination of two or more.

Further, examples of the ligand-coordinated transition metal complex include bis(triphenylphosphine)nickel chloride, bis(triphenylphosphine)nickel bromide, bis(triphenylphosphine)nickel iodide, bis(triphenylphosphine)nickel nitrate, (2,2′-bipyridine)nickel chloride, (2,2′-bipyridine)nickel bromide, (2,2′-bipyridine)nickel iodide, (2,2′-bipyridine)nickel nitrate, bis(1,5-cyclooctadiene)nickel, tetrakis(triphenylphosphine)nickel, tetrakis(triphenylphosphite)nickel, and tetrakis(triphenylphosphine)palladium. Of the above-described ligand-coordinated transition metal complexes, bis(triphenylphosphine)nickel chloride and (2,2′-bipyridine)nickel chloride are preferred.

As the reducing agent usable in the catalyst system, iron, zinc, manganese, aluminum, magnesium, sodium, calcium, and the like can be given. Of these reducing agents, zinc, magnesium, and manganese are preferred. The reducing agent may be used in a further activated state by bringing it into contact with an acid such as an organic acid.

Further, examples of the salt which can be used in the catalyst system include sodium compounds such as sodium fluoride, sodium chloride, sodium bromide, sodium iodide, and sodium sulfate; potassium compounds such as potassium fluoride, potassium chloride, potassium bromide, potassium iodide, and potassium sulfate; and ammonium compounds such as tetraethylammonium fluoride, tetraethylammonium chloride, tetraethylammonium bromide, tetraethylammonium iodide, and tetraethylammonium sulfate. Of these salts, sodium bromide, sodium iodide, potassium bromide, tetraethylammonium bromide, and tetraethylammonium iodide are preferred.

The transition metal salt or transition metal complex is used in an amount of usually from 0.0001 to 10 mols, preferably from 0.01 to 0.5 mol per 1 mol of the sum of the compound represented by the formula (6) and the compound represented by the formula (7). Amounts less than 0.0001 mol cannot always accelerate the polymerization reaction fully. Amounts exceeding 10 mols, on the other hand, may reduce the molecular weight of the resulting polymer.

When the transition metal salt and ligand component are used in the above-described catalyst system, the ligand component is used in an amount of usually from 0.1 to 100 mols, preferably from 1 to 10 mols per 1 mol of the transition metal salt. When its amount is less than 0.1 mol, the catalyst system cannot exhibit catalytic activity fully. Amounts exceeding 100 mols, on the other hand, may reduce the molecular weight of the resulting polymer.

In the catalyst system, the reducing agent is used in an amount of usually from 0.1 to 100 mols, preferably from 1 to 10 mols per 1 mol of the sum of the compound represented by the formula (6) and the compound represented by the formula (7). Amounts less than 0.1 mol cannot always accelerate the polymerization fully. Amounts exceeding 100 mols, on the other hand, may make it difficult to purify the resulting polymer.

Also, in the catalyst system, when the salt is used, it is added in an amount of usually from 0.001 to 100 mols, preferably from 0.01 to 1 mol per 1 mol of the sum of the compound represented by the formula (6) and the compound represented by the formula (7). Amounts less than 0.001 mol may be sometimes insufficient for raising the polymerization rate. Amounts exceeding 100 mols, on the other hand, make it difficult to purify the resulting polymer.

Also, examples of the polymerization solvent usable for the copolymerization reaction include tetrahydrofuran, cyclohexanone, dimethylsulfoxide, N,N-dimethylformamide, N,N-dimethylacetamide, N-methyl-2-pyrrolidone, γ-butyrolactone, sulfolane, γ-butyrolactam, dimethylimidazolidinone and tetramethylurea. Of these, tetrahydrofuran, N,N-dimethylformamide, N,N-dimethylacetamide, and N-methyl-2-pyrrolidone are desirable. The polymerization solvent is preferably used after sufficient drying.

The total concentration of the compound represented by the formula (6) and the compound represented by the formula (7) in the polymerization solvent is usually from 1 to 90 wt %, preferably from 5 to 40 wt %. The polymerization temperature is usually from 0 to 200° C., preferably from 50 to 120° C. The polymerization time is usually from 0.5 to 100 hours, preferably from 1 to 40 hours.

The polyarylene polymer obtained in the above-described manner has a molecular weight, as polystyrene-equivalent weight-average molecular weight by gel permeation chromatography (which will hereinafter be abbreviated as “GPC”), of from 10,000 to 1,000,000, preferably from 20,000 to 800,000. When the polystyrene-equivalent weight-average molecular weight is less than 10000, the film formed from it has insufficient film properties, for example, cracks appear therein and in addition, it has a problem in its strength-related properties. When the polystyrene-equivalent weight-average molecular weight exceeds 1,000,000, on the other hand, the resulting polymer has insufficient solubility and high solution viscosity, leading to problems such as poor proccessability.

The sulfonated polyarylene polymer may be obtained by sulfonation of the polyarylene polymer itself; or synthesizing a sulfonate ester of the polyarylene polymer by using a compound of the formula (6) equipped with Ar substituted by a sulfonate ester group and then hydrolyzing the sulfonate ester into the corresponding sulfonated polyarylene polymer.

The polyarylene polymer having no sulfonic acid group is sulfonated by introducing a sulfonic acid group into the polyarylene polymer by using a sulfonating agent. The introduction of the sulfonic acid group can be carried out, for example, by sulfonating the sulfonic-acid-free polyarylene polymer by using a known sulfonating agent such as sulfuric anhydride, fuming sulfuric acid, chlorosulfonic acid, sulfuric acid or sodium hydrogen sulfite under known conditions (refer to, for example, Polymer Preprints, Japan, 42(3), 730(1993), Polymer Preprints, Japan, 43(3), 736(1994), Polymer Preprints, Japan, 42(7), 2490-2492(1993)).

That is, the sulfonation is carried out under the following conditions. The sulfonic-acid-free polyarylene polymer is reacted with the sulfonating agent in a solventless manner or in the presence of a solvent. Examples of the solvent include hydrocarbon solvents such as n-hexane, ether solvents such as tetrahydrofuran and dioxane, aprotic polar solvents such as dimethylacetamide, dimethylformamide and dimethylsulfoxide, and halogenated hydrocarbons such as tetrachloroethane, dichloroethane, chloroform, and methylene chloride. Although no particular limitation is imposed on the reaction temperature, it is usually from −50 to 200° C., preferably from −10 to 100° C. The reaction time is usually from 0.5 to 1000 hours, preferably from 1 to 200 hours.

On the other hand, when the sulfonate ester of the polyarylene polymer is hydrolyzed into the corresponding sulfonated polyarylene polymer, a sulfonate ester of the polyarylene polymer is first synthesized by reacting a compound, which is represented by the formula (6) and equipped with Ar substituted with a sulfonate ester group, with a compound represented by the formula (7) in a similar manner to that employed for the above-described copolymerization reaction.

Examples of the compound, which is represented by the formula (6) and equipped with Ar substituted with a sulfonate ester group, include aromatic sulfonate ester derivatives as shown below:

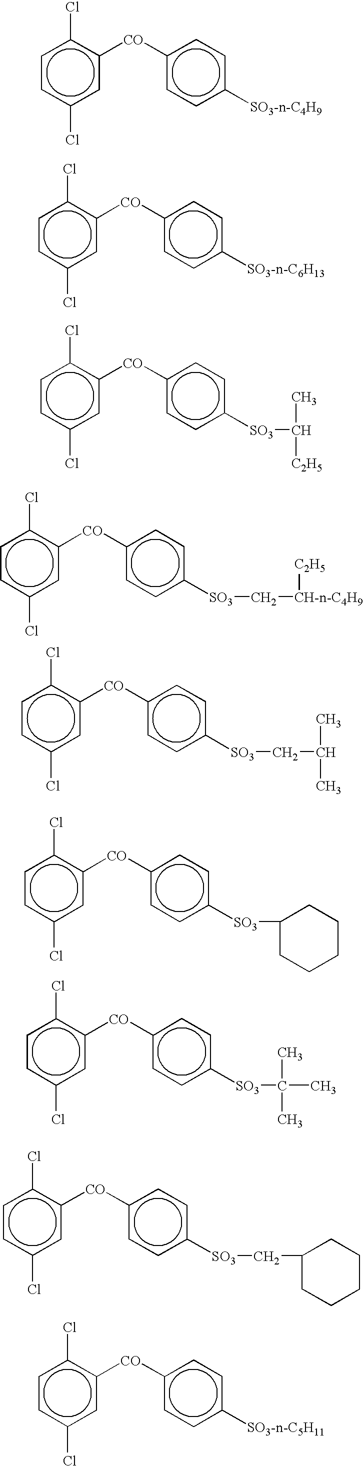

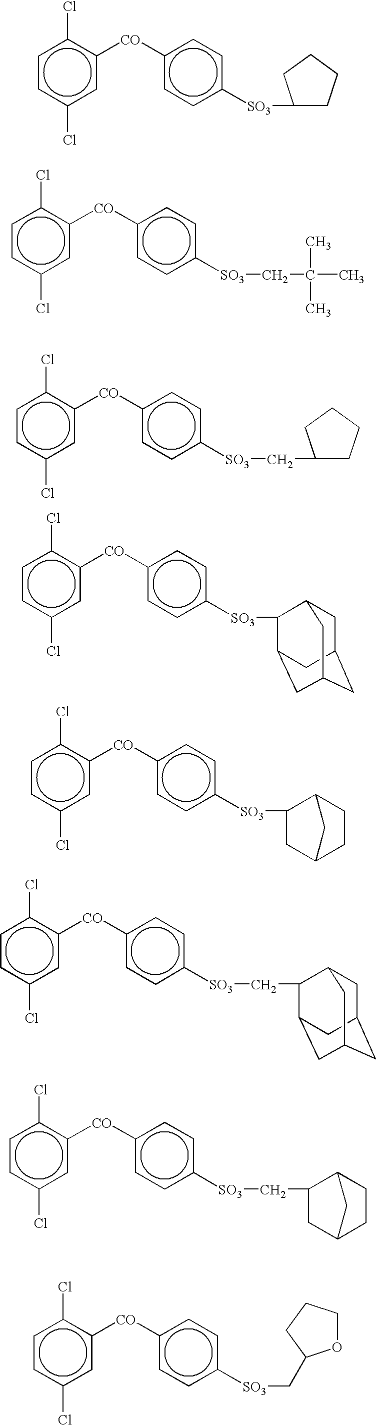

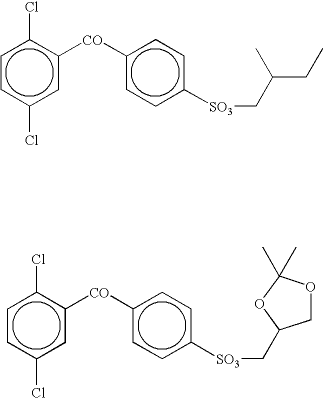

Additional examples of the aromatic sulfonate ester derivatives include compounds obtained by substituting the chlorine atom of the above-described compounds with a bromine atom, compounds obtained by substituting the —CO— of the above-described compounds with —SO₂—, and compounds obtained by substituting the chlorine atom and —CO— of the above-described compounds with a bromine atom and —SO₂—, respectively.

The ester group is preferably derived from a primary alcohol and has a tertiary or quaternary carbon at the β position thereof in that it is excellent in stability during polymerization and free from inhibition of polymerization or cross-linking derived from generation of sulfonic acid by deesterification. More preferably, it is derived from a primary alcohol and has a quaternary carbon at the β position thereof.

The aromatic sulfonate ester derivative can be synthesized, for example, in the following manner.

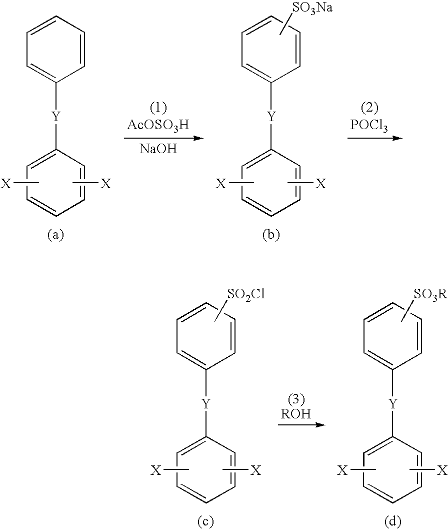

For the synthesis of the aromatic sulfonate derivative, first, an aromatic derivative (a) in accordance with the formula (6) is sulfonated (converted into sodium sulfonate salt). The sulfonation is effected, for example, by reacting a 1,2-dichloromethane solution of 2,5-dichlorobenzophenone with 5 times the mol of a 1.2-dichloromethane solution of acetylsulfuric acid at 60° C. for from 3 to 5 hours. After the reaction, the reaction is terminated by 1-propanol and the reaction mixture is poured into 3 times the mol of an aqueous NaOH solution. The resulting solution can be concentrated into a sodium sulfate salt (b) in the fine powder form.

Then, the resulting sodium sulfate salt (b) is converted into sulfonic acid chloride. The conversion into sulfonic acid chloride is effected, for example, by adding, to sodium 2,5-dichlorobenzophenone-3′-sulfonate as the sodium sulfonate salt (b), from about 3 to 4 times (weight/volume) of a solvent (a 4/6 (volumetric ratio)=sulfolane/acetonitrile mixed solvent) to dissolve sodium 2,5-dichlorobenzophenone-3′-sulfonate in the solvent, heating to 70° C. and reacting the resulting solution with phosphoryl chloride at around 10° C. for about 5 hours. After the reaction, the reaction mixture is diluted with large excess of cool water to cause precipitation. The diluted mixture was filtered, followed by recrystallization from toluene, whereby purified crystals of sulfonic acid chloride (c) are obtained.

In addition, compound (a) can be converted into sulfonic acid chloride (c) at one time by using from 5 to 10 times the molar amount of chlorosulfonic acid instead of the above-described acetylsulfuric acid.

Next, the sulfonic acid chloride (c) is then converted into the corresponding sulfonate ester. For example, relative to 2,5-dichlorobenzophenone-3′-sulfonic acid chloride as the sulfonic acid chloride (c), at least an equivalent amount (usually, from 1 to 3 times the molar amount) of a mixed solution obtained by cooling i-butyl alcohol and pyridine is employed. To the mixed solution is added dropwise 2,5-dichlorobenzophenone-3′-sulfonic acid chloride. The reaction is effected at a temperature controlled to 20° C. or less. The reaction time is for from about 10 minutes to 5 hours, though depending on the reaction scale. After the reaction mixture is treated with diluted hydrochloric acid and washed with water, the target compound is extracted using ethyl acetate. The extract is concentrated to separate the target compound therefrom, followed by recrystallization from methanol, whereby an aromatic sulfonate ester derivative (d) can be obtained.

The sulfonate ester of the polyarylene polymer can be hydrolyzed, for example, by charging the sulfonate ester of the polyarylene polymer in an excess amount of water or alcohol containing a small amount of hydrochloric acid and stirring the resulting mixture for 5 minutes or greater; by reacting the sulfonate ester of the polyarylene polymer in trifluoroacetic acid at from about 80 to 120° C. for from about 5 to 10 hours; or by reacting the sulfonate ester of the polyarylene polymer in a solution, such as a solution of N-methylpyrrolidone, containing from 1 to 3 times the molar amount of lithium bromide per mol of the sulfonate ester group (—SO₃R) in the polyarylene polymer for from about 3 to 10 hours at from about 80 to 150° C. and then adding hydrochloric acid to the resulting reaction mixture.

By the above-described hydrolysis, the sulfonate ester group (—SO₃R) of the sulfonate ester of the polyarylene polymer is converted into a sulfonic acid group (—SO₃H), whereby the corresponding sulfonated polyarylene polymer can be obtained. It is preferred that in the sulfonated polyarylene polymer, at least 90% of the sulfonate ester group (—SO₃R) in the sulfonate ester of the polyarylene polymer has been converted into a sulfonic acid group (—SO₃H).

The sulfonated polyarylene polymer thus obtained has from 0.5 to 3 meq/g, preferably from 0.8 to 2.8 meq/g of a sulfonic acid group. When the amount of the sulfonic acid group in the sulfonated polyarylene polymer is less than 0.5 meq/g, the polymer sometimes does not have sufficient proton conductivity. When the amount of the sulfonic acid group in the polymer exceeds 3.0 meq/g, on the other hand, the polymer has improved hydrophilic property and inevitably becomes a water soluble polymer; even if it does not become a water soluble polymer, it may become soluble in hot water; or it may have reduced durability, though it does not become water soluble.

The above-described amount of the sulfonic acid group can be adjusted readily by changing a ratio of the compound represented by the formula (6) to the compound represented by the formula (7) or kinds or combination of the compound represented by the formula (6) and the compound represented by the formula (7).

In addition, the structure of the sulfonated polyarylene polymer can be confirmed by S═O absorption at 1,030 to 1,045 cm⁻¹ and 1,160 to 1,190 cm⁻¹, C—O—C absorption at 1,130 to 1,250 cm⁻¹, and C═O absorption at 1,640 to 1,660 cm⁻¹ in the infrared absorption spectrum. Their compositional ratio can be known by neutralization titration of sulfonic acid or elemental analysis. The structure of the sulfonated polyarylene polymer can be confirmed from the peak of aromatic protons at 6.8 to 8.0 ppm in the nuclear magnetic resonance spectrum (¹H-NMR).

A solid polymer electrolyte membrane 1 can be prepared by dissolving the sulfonated polyarylene polymer in a solvent, casting the resulting solution on a substrate and forming the solution into a film by the casting method or the like. The solid polymer electrolyte membrane 1 may contain, to an extent not damaging its proton conductivity, an antioxidant such as phenolic hydroxyl-containing compound, amine compound, organic phosphorus compound or organic sulfur compound. When the solid polymer electrolyte membrane 1 is prepared in the form of a film, the sulfonated polyarylene polymer may be used in combination with an inorganic acid such as sulfuric acid or phosphoric acid, an organic acid including carboxylic acid, an adequate amount of water or the like.

No particular limitation is imposed on the substrate insofar as it is a substrate used for ordinary solution casting method. For example, a substrate made of plastic or metal, a glass plate or the like can be used. The substrate is preferably made of a thermoplastic resin such as a polyethyleneterephthalate (PET) film.

Examples of the solvent for dissolving the sulfonated polyarylene polymer therein include aprotic polar solvents such as N-methyl-2-pyrrolidone, N,N-dimethylformamide, γ-butyrolactone, N,N-dimethylacetamide, dimethyl sulfoxide, dimethylurea and dimethylimidazolidinone. From the viewpoints of solubility and viscosity of the solution, N-methyl-2-pyrrolidone (which will hereinafter be abbreviated as NMP) is especially preferred. The above-described aprotic polar solvents may be used either singly or in combination of two or more.

Also, a mixture of the aprotic polar solvent and an alcohol may be used as the solvent for dissolving the sulfonated polyarylene polymer therein. Examples of the alcohol include methanol, ethanol, propyl alcohol, iso-propyl alcohol, sec-butyl alcohol and tert-butyl alcohol. Of these, methanol is especially preferred because it is effective for lowering the viscosity of the solution in a wide compositional range. These alcohols may be used either singly or in combination of two or more.

When the mixture of the aprotic polar solvent and the alcohol is used as the solvent, the mixture is composed of from 95 to 25 wt %, preferably from 90 to 25 wt % of the aprotic polar solvent and from 5 to 75 wt %, preferably from 10 to 75 wt % of the alcohol (100 wt % in total). The amount of the alcohol adjusted to fall within the above-described range has excellent effects for lowering the solution viscosity.

The polymer concentration in the solution having the sulfonated polyarylene polymer dissolved therein is usually from 5 to 40 wt %, preferably from 7 to 25 wt %, though depending on the molecular weight of the sulfonated polyarylene polymer. The solution having a polymer concentration less than 5 wt % has difficulty in forming a thick film and the film formed using it tends to have pin holes. When the polymer concentration of the solution exceeds 40 wt %, on the other hand, the solution cannot easily be formed into a film because of a too high solution viscosity. In addition, the film thus obtained may have insufficient surface flatness.

In this instance, the viscosity of the solution is usually from 2,000 to 100,000 mPa·s, preferably from 3,000 to 50,000 mPa·s, though depending on the molecular weight of the sulfonated polyarylene polymer or polymer concentration. When the solution viscosity is less than 2,000 mPa·s, the solution during the film formation may flow from the substrate due to poor retention. When it exceeds 100,000 mPa·s, the solution cannot be extruded from a die due to a too high viscosity, making it difficult to form a film by the casting method.

After the film is formed as described above, the resulting undried film is immersed in water, whereby the organic solvent in the undried film can be replaced by water and the residual solvent amount in the solid polymer electrolyte membrane 1 can be reduced.

The undried film may be pre-dried before immersing the undried film in water after the film formation. The undried film can be pre-dried by retaining it usually at a temperature of from 50 to 150° C. for 0.1 to 10 hours.

The undried film may be immersed in water by using a batch process in which each sheet of the film is immersed in water, or a continuous process in which a film stack formed on an ordinarily available substrate film (PET, for example) or film separated from the substrate is immersed in water and wound. The batch process is advantageous because occurrence of wrinkles on the surface of the treated film can be suppressed by putting the treated film in a frame.

The undried film is immersed in water so that 1 part by weight of the undried film is brought into contact with at least 10 parts by weight, preferably at least 30 parts by weight of water. For minimizing a residual solvent amount in the resulting solid polymer electrolyte membrane, the contact ratio is preferably kept at a higher level. For reducing the residual solvent amount of the solid polymer electrolyte membrane 1, it is also effective to constantly maintain the organic solvent concentration in water not greater than a predetermined concentration by replacing water used for immersion or causing water to overflow. For reducing in-plane distribution of an organic solvent amount remaining in the solid polymer electrolyte membrane 1, homogenization of the organic solvent concentration in water by stirring or the like is effective.

The temperature of water when the undried film is immersed therein preferably falls within a range of from 5 to 80° C. When the temperature of water is higher, the rate of substitution of the organic solvent by water becomes higher and the water absorption amount of the film becomes greater. There is therefore a fear of coarsening of the surface of the solid polymer electrolyte membrane 1 available after drying. The temperature range of water from 10 to 60° C. is preferred from the viewpoint of the rate of substitution and handling ease. The immersion time is usually from 10 minutes to 240 hours, preferably from 30 minutes to 100 hours, though depending on the initial residual amount of the solvent, contact ratio, or treatment temperature.

When the undried film is dried after it is immersed in water as described above, the solid polymer electrolyte membrane 1 having a reduced residual solvent amount is available. The solid polymer electrolyte membrane 1 thus obtained has a residual solvent amount of usually 5 wt % or less.

Also, the residual solvent amount of the solid polymer electrolyte membrane 1 can be reduced to 1 wt % or less, depending on the immersion conditions. As such conditions, for example, the amount of water to be brought into contact with 1 part by weight of the undried film is set at 50 parts by weight or greater, temperature of water during immersion is set at from 10 to 60° C., and immersion time is set at from 10 minutes to 10 hours.

After immersion of the undried film in water as described above, the film is dried at from 30 to 100° C., preferably from 50 to 80° C. for from 10 to 180 minutes, preferably from 15 to 60 minutes. The film is then vacuum-dried at from 50 to 150° C., preferably at a reduced pressure of from 500 mmHg to 0.1 mmHg for from 0.5 to 24 hours to obtain the solid polymer electrolyte membrane 1.

Also, the solid polymer electrolyte membrane 1 obtained by the process of the present invention has a dry film thickness of usually from 10 to 100 μm, preferably from 20 to 80 μm.

The solid polymer electrolyte membrane 1 can also be prepared by forming the sulfonate ester of the polyarylene polymer into a film in the above-described manner without hydrolyzing it and then hydrolyzing the film in the above-described manner.

The solid polymer electrolyte membrane 1 may contain an antiaging agent, preferably a hindered-phenol compound having a molecular weight of 500 or greater. The solid polymer electrolyte membrane 1 can have improved durability by containing the antiaging agent.

Examples of the hindered phenol compound having a molecular weight of 500 or greater include: triethylene glycol-bis[3-(3-t-butyl-5-methyl-4-hydroxyphenyl)propionate] (trade name: IRGANOX 245),

1,6-hexanediol-bis[3-(3,5-di-t-butyl-4-hydroxyphenyl)propionate] (trade name: IRGANOX 259), 2,4-bis-(n-octylthio)-6-(4-hydroxy-3,5-di-t-butylanilino)-3,5-triazine (trade name: IRGANOX 565), pentaerythrityl-tetrakis[3-(3,5-di-t-butyl-4-hydroxyphenyl)propionate] (trade name: IRGANOX 1010),

2,2-thio-diethylenebis[3-(3,5-di-t-butyl-4-hydroxyphenyl)propionate] (trade name: IRGANOX 1035),

octadecyl-3-(3,5-di-t-butyl-4-hydroxyphenyl)propionate (trade name: IRGANOX 1076),

N,N-hexamethylenebis(3,5-di-t-butyl-4-hydroxy-hydrocinnamide) (trade name: IRGANOX 1098),

1,3,5-trimethyl-2,4,6-tris(3,5-di-t-butyl-4-hydroxybenzyl)benzene (trade name: IRGANOX 1330),

tris-(3,5-di-t-butyl-4-hydroxybenzyl)-isocyanurate (trade name: IRGANOX 3114), and

3,9-bis[2-[3-(3-t-butyl-4-hydroxy-5-methylphenyl)propionyloxy]-1,1-dimethylethyl]-2,4,8,10-tetraoxaspiro[5.5]undecane (trade name: Sumilizer GA-80).

The hindered-phenol compound having a molecular weight of 500 or greater is added preferably in an amount of from 0.01 to 10 parts by weight to 100 parts by weight of the sulfonated polyarylene polymer.

The above-described electrode catalyst layer 2 is composed of a catalyst and an ion-conductive polymer electrolyte.

The above-described catalyst is preferably a supported catalyst obtained by supporting platinum or a platinum alloy on a carbon material having pores developed therein. Carbon black, active carbon or the like can be preferably used as the carbon material having pores developed therein. Examples of the carbon black include channel black, furnace black, thermal black and acetylene black, while those of the active carbon include those obtained by carbonating and activating various carbon-containing materials. These carbon materials may be subjected to graphitization.

Although the above-described catalyst may be that having platinum supported on a carbon carrier, use of a platinum alloy can impart the catalyst with stability and activity required for an electrode catalyst. As the platinum alloy, alloys between platinum and at least one metal selected from the group consisting of platinum metals other than platinum such as ruthenium, rhodium, palladium, osmium and iridium, cobalt, iron, titanium, gold, silver, chromium, manganese, molybdenum, tungsten, aluminum, silicon, rhenium, zinc and tin. The platinum alloy may contain an intermetallic compound of platinum and a metal to be alloyed.

The support ratio (a ratio of the mass of platinum or platinum alloy relative to the total mass of the supported catalyst) of platinum or platinum alloy is preferably from 20 to 80 mass %, especially from 30 to 55 mass % in order to attain a high output. When the support ratio is less than 20 mass %, there is a fear of a sufficient output being not attained. When it exceeds 80 mass %, on the other hand, there is a fear of platinum or platinum alloy particles not being supported by a carbon material, which serves as a carrier, with good dispersibility.

Also, the primary particle size of platinum or platinum alloy is preferably from 1 to 20 nm in order to obtain a highly active gas diffusion electrode, especially preferably from 2 to 5 nm to assure a large surface area of platinum or platinum alloy from the viewpoint of reaction activity. The platinum or platinum alloy is preferably contained in an amount ranging from 0.01 to 1.0 mg/cm² in the catalyst particles.

The electrode catalyst layer 2 contains, in addition to the supported catalyst, an ion conductive polymer electrolyte having a sulfonic acid group. The supported catalyst is usually covered with the polymer electrolyte and proton (H+) transfers, passing through a channel via which the polymer electrolyte is connected.

As the ion conductive polymer electrolyte having a sulfonic acid group, a perfluoroalkylenesulfonic acid polymer compound is suitably used because it provides excellent adhesion between it and the solid polymer electrolyte membrane 1. Examples of the perfluoroalkylenesulfonic acid polymer compound include “Nafion” (trade mark, product of Dupont), “Flemion” (trade mark, product of Asahi Glass), and “ACIPLEX” (trade name; product of Asahi Kasei). As the ion conductive polymer electrolyte, ion conductive polymer electrolytes composed mainly of an aromatic hydrocarbon compound such as sulfonated polyarylene polymer as described herein may be used instead of the perfluoroalkylenesulfonic acid polymer compound.

### EXAMPLE 1

In a 1-L three-necked flask equipped with a stirrer, thermometer, Dean-stark trap, nitrogen inlet tube and condenser tube, 48.8 g (284 mmol) of 2,6-dichlorobenzonitrile, 89.5 g (266 mmol) of 2,2-bis(4-hydroxyphenyl)-1,1,1,3,3,3-hexafluoropropane and 47.8 g (346 mmol) of potassium carbonate were weighed. After purging with nitrogen, 346 ml of sulfolane and 173 ml of toluene were added and the resulting mixture was stirred. The reaction mixture was then heated under reflux over an oil bath at 150° C. Water produced by the reaction was taken out of the system by the Dean-stark trap. After the heating under reflux was continued for 3 hours and generation of water was scarcely recognized, toluene was taken out of the system by the Dean-stark trap. The reaction temperature was raised gradually to 200° C., at which stirring was continued for 3 hours. To the reaction mixture was added 9.2 g (53 mmol) of 2,6-dichlrobenzonitrile and the reaction was continued for further 5 hours.

After the reaction mixture was allowed to cool, 100 ml of toluene was added to dilute it therewith. An inorganic salt insoluble in the reaction mixture was filtered and the filtrate was poured into 2 liter of methanol to cause precipitation. The precipitate thus obtained was filtered, dried and then dissolved in 250 ml of tetrahydrofuran (THF). The resulting solution was poured into 2 liter of methanol to cause re-precipitation. The white powder thus precipitated was filtered and dried, whereby 109 g of the target compound was obtained.

Next, the polystyrene-equivalent number-average molecular weight (Mn) of the resulting compound was determined in accordance with GPC by using THF as a solvent. The resulting compound had Mn of 9,500. It was confirmed by ¹H-NMR spectrum that the compound thus obtained was an oligomer represented by the following formula (I):

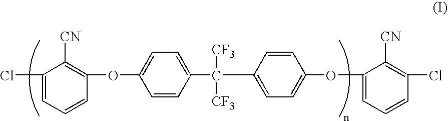

Next, in a 1-L three-necked flask equipped with a stirrer, thermometer and nitrogen inlet tube, 135.2 g (337 mmol) of neopentyl 3-(2,5-dichlorobenzoyl)benzenesulfonate, 48.7 g (5.1 mmol) of the oligomer of the formula (I) having Mn of 9,500, 6.71 g (10.3 mmol) of bis(triphenylphosphine)nickel dichloride, 1.54 g (10.3 mmol) of sodium iodide, 35.9 g (137 mmol) of triphenylphosphine and 53.7 g (821 mmol) of zinc were weighed, followed by purging with dry nitrogen. Then, 430 ml of N,N-dimethylacetamide (DMAc) was added. Stirring was continued for 3 hours while maintaining the reaction temperature at 80° C. The reaction mixture was diluted with 730 ml of DMAc and an insoluble matter was filtered.

The resulting solution was charged in a 2-L three-necked flask equipped with a stirrer, thermometer and nitrogen inlet tube. After heating to 115° C., the solution was stirred and 44 g (506 mmol) of lithium bromide was added. After stirring for 7 hours, the reaction mixture was poured in 5 liter of acetone to cause precipitation. The precipitate thus obtained was washed successively with 1M hydrochloric acid and pure water, followed by drying, whereby 122 g of the target polymer was obtained.

The polystyrene-equivalent weight average molecular weight (Mw) of the resulting polymer was determined in accordance with GPC by using, as a solvent, N-methyl-2-pyrrolidone (NMP) to which lithium bromide and phosphoric acid had been added. The resulting polymer had Mw of 135,000. It was confirmed by ¹H-NMR spectrum that the compound thus obtained was a sulfonated polymer represented by the following formula (II):

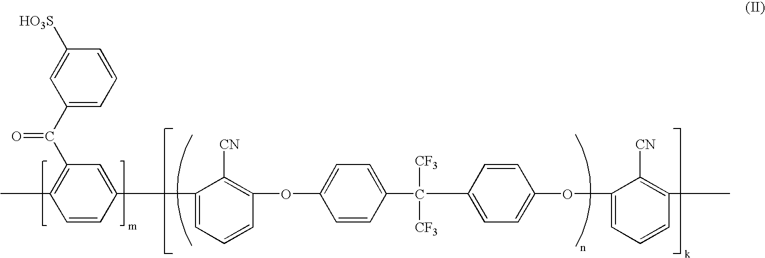

A 8 wt % NMP solution of the sulfonated polymer obtained in this Example was cast onto a glass plate to form a film. After air drying and then vacuum drying, a film having a dry film thickness of 40 μm was obtained.

Next, using the film, a membrane-electrode assembly was manufactured in the following procedure.

First, catalyst particles were prepared by having platinum particles supported on carbon black (Furnace black) having an average diameter of 50 nm at a carbon black:platinum weight ratio of 1:1. The resulting catalyst particles were uniformly dispersed in a solution of a perfluoroalkylenesulfonic acid polymer compound (“Nafion”, trade mark; product of Dupont) serving as an ion conductive binder at an ion conductive binder:catalyst particles weight ratio of 8:5, whereby a catalyst paste was prepared.

Next, carbon black and polytetrafluoroethylene (PTEFE) particles were then mixed at a carbon black: PTFE particles weight ratio of 4:6. A slurry obtained by uniformly dispersing the resulting mixture in ethylene glycol was applied to one side of carbon paper and then dried to form a base layer. Two gas diffusion layers each composed of the base layer and carbon paper were prepared.

Next, the catalyst paste was then applied to both sides of the above-described film, which was used as the polymer electrolyte membrane, to give a platinum content of 0.5 mg/cm² by a bar coater, followed by drying, whereby an electrode catalyst layer was formed and an electrode coated membrane (CCM) was obtained. The above-described drying was comprised of drying at 100° C. for 15 minutes and secondary drying at 140° C. for 10 minutes.

The above-described CCM was inserted between the gas diffusion layers on the base layer side thereof and hot pressed to obtain a membrane-electrode assembly. The above-described hot-press was comprised of primary hot press at 80° C. and 5 MPa for 2 minutes and secondary hot press at 160° C. and 4 MPa for 1 minute.

By stacking a separator serving also as a gas passage over the gas diffusion layers of the membrane-electrode assembly obtained in this Example, a solid polymer electrolyte fuel cell can be formed.

Next, the physical properties of each of the sulfonated polymer, polymer electrolyte membrane and membrane-electrode assembly obtained in this Example and power generation characteristics of the membrane-electrode assembly were evaluated as described below. The results are shown in Table 1.

[Ion Exchange Capacity of Sulfonated Polymer]

The sulfonated polymer thus obtained was washed with water until the water had a pH of from 4 to 6 and the remaining free acid was removed. After sufficient washing with water and drying, a predetermined amount of the polymer was weighed and dissolved in a mixed solvent of THF and water. The resulting solution was titrated with a standard solution of NaOH while using phenolphthalein as an indicator and the ion exchange capacity of the sulfonated polymer was determined from the point of neutralization.

[Proton Conductivity of Polymer Electrolyte Membrane]

The polymer electrolyte membrane cut into 5-mm wide rectangles was used as a sample. The sample was maintained in a thermo-hygrostat maintained at 85° C. and relative humidity of 90%. Five platinum lines (diameter: 0.5 mm) were pressed spaced apart against the surface of the sample and the alternating-current resistance was measured by a resistance measuring apparatus while changing the line-line distance between from 5 to 20 mm. As the thermo-hygrostat, a compact environmental testing equipment “SH-241” (trade name); product of ESPEC CORP was used, while as the resistance measuring apparatus, “SI1260 Impedance Analyzer” (trade name); product of Solartron was used.

The specific resistance of the polymer electrolyte membrane was calculated from the line-line distance and the gradient of the resistance. The alternating-current impedance was calculated from the reciprocal of the specific resistance, and the proton conductivity of the polymer electrolyte membrane was calculated from the impedance.

Specific resistance R (Ω·cm)=0.5 (cm)×membrane thickness (cm)×gradient of resistance and line-line distance (Ω/cm)

[Hot Water resistance of Polymer Electrolyte Membrane]

The polymer electrolyte membrane was cut into a 2.0 cm×3.0 cm piece and the piece was weighed and used as a sample. The sample was put into a 250-mL bottle made of polycarbonate. About 100 ml of distilled water was charged in the bottle, followed by hot water treatment by heating at 120° C. for 24 hours by using a pressure cooker tester (“PC242HS” (trade name); product of HIRAYAMA MFS CORP).

Next, the sample was then taken out from hot water, the size of the sample was measured, and a percentage size change relative to the size of the sample before the hot water treatment was determined. In addition, the sample after the hot water treatment was dried for 5 hours in vacuum and then weighed. A percentage weight retention relative to the weight of the sample before the hot water treatment was determined and used as an indicator of hot water resistance of the polymer electrolyte membrane.

[Resistance of the Polymer Electrolyte Membrane to Fenton Reagent]

The polymer electrolyte membrane cut into a 3.0 cm×4.0 cm piece was weighed and used as a sample. A 3 wt % of hydrogen peroxide was mixed with iron sulfate heptahydrate to give an iron ion concentration of 20 ppm, whereby a Fenton reagent was prepared. In a 250-mL container made of polyethylene was collected 200 g of the resulting Fenton reagent. After the sample was charged in the container, the container was hermetically sealed. It was dipped in a constant-temperature water bath of 45° C. for 10 hours. After the sample was then taken out, it was washed with ion exchange water, dried at 25° C. and relative humidity of 50% for 12 hours and weighed. A percentage weight retention relative to the weight of the sample before the treatment was determined and used as an indicator of resistance of the polymer electrolyte membrane to Fenton reagent.

[Adhesion of Membrane-Electrode Assembly]

The electrode coated membrane (CCM) having an electrode layer formed thereon by applying the above-described catalyst paste to both sides of the polymer electrolyte membrane was charged in a dew condensation cycle tester (“DCTH-200” (trade name) product of ESPEC CORP). Thermal shock cycle treatment was conducted by repeating 20 times the cycle in which a state at 85° C. and relative humidity of 95% and a state at −20° C. were repeated regularly. The CCM after the thermal shock cycle treatment cut into a 1.0 cm×5.0 cm rectangle and fixed onto an aluminum plate by a two-sided adhesive tape was used as a sample. An adhesive tape was firmly attached to the surface of the electrode layer on the sample-exposed side and pulled by an SPG load measuring apparatus “HPC A50.500” (trade name); product of Hoko Engineering at a rate of 50 mm/min in a direction away from the sample, whereby a peel test for peeling the electrode layer from the polymer electrolyte membrane was performed. After the peel test, the sample was subjected to image processing and the remaining area of the electrode layer was calculated. In accordance with the below-described equation, a percentage electrode adhesion was determined and used as an indicator of adhesion of the membrane-electrode assembly. The data processing was carried out by scanning a picture via “Scanner GT-8200U” (trade name); product of Seiko Epson and binarizing it.
Percentage electrode adhesion (%)=Remaining area of electrode layer/total sample area
[Power Generation Characteristics of Membrane-Electrode Assembly]

Cell potential when electricity was generated by using the membrane-electrode assembly and supplying pure hydrogen and air to the fuel electrode side and oxygen electrode side, respectively under power generation conditions of cell temperature of 70° C., relative humidity of 60% on the fuel electrode side, and relative humidity of 40% on the oxygen electrode side was determined and used as an indicator of the power generation performance of the membrane-electrode assembly.

Also, in a similar manner to that described above except that the cell temperature was 115° C. and relative humidity was 30% on each of the fuel electrode side and oxygen electrode side, electricity was generated by using the membrane-electrode assembly. Time until occurrence of the crossleak was measured at a current density adjusted to 0.1 A/cm² and used as an indicator of power generation durability of the membrane-electrode assembly.

Also, a capacity reduction amount at cell potential of 0.8 A/cm² when starting of power generation at −30° C. was repeated 10 times by using the membrane-electrode assembly was measured and used as an indicator of low temperature durability of the membrane-electrode assembly. When the capacity reduction amount at the cell potential is less than 20 mV, the low temperature durability was rated as good, while when it was 20 mV or greater, the low temperature durability was rated as poor.

### EXAMPLE 2

In a similar manner to Example 1 except that 49.4 g (287 mmol) of 2,6-dichlorobenzonitrile, 88.4 g (263 mmol) of 2,2-bis(4-hydroxyphenyl)-1,1,1,3,3,3-hexafluoropropane and 47.3 g (342 mmol) of potassium carbonate were charged for reaction and the amount of 2,6-dichlorobenzonitrile added in the latter stage of the reaction was changed to 2.3 g (72 mmol), 107 g of the compound represented by the formula (I) was obtained. The number average molecular weight (Mn) by GPC of the compound of the formula (I) obtained in this Example was 7,300.

Next, in a similar manner to Example 1 except for the use of 134.6 g (336 mmol) of neopentyl 3-(2,5-dichlorobenzoyl)benzenesulfonate, 47.4 g (6.5 mmol) of the oligomer of the formula (1) having Mn of 7,300, 6.71 g (10.3 mmol) of bis(triphenylphosphine)nickel dichloride, 1.54 g (10.3 mmol) of sodium iodide, 35.9 g (137 mmol) of triphenylphosphine and 53.7 g (821 mmol) of zinc, 129 g of a sulfonated polymer represented by the formula (II) was obtained. The sulfonated polymer of the formula (II) obtained in this Example had a weight average molecular weight (Mw) by GPC of 140,000.

Next, in a similar manner to Example 1 except for the use of the sulfonated polymer obtained in this Example, a membrane-electrode assembly was prepared.

Next, physical properties of the sulfonated polymer, polymer electrolyte membrane and membrane-electrode assembly obtained in this Example, and power generation properties of the membrane-electrode assembly were rated in exactly the same manner as in Example 1. The results are shown in Table 1.

### EXAMPLE 3

In a 1-L three-necked 1-L flask equipped with a stirrer, thermometer, Dean-stark trap, nitrogen inlet tube and condenser tube, 44.5 g (259 mmol) of 2,6-dichlorobenzonitrile, 102.0 g (291 mmol) of 9,9-bis(4-hydroxyphenyl)-fluorene and 52.3 g (349 mmol) of potassium carbonate were weighed. After purging with nitrogen, 366 ml of sulfolane and 183 ml of toluene were added and the mixture was stirred. The reaction mixture was then heated under reflux over an oil bath at 150° C. Water produced by the reaction was taken out of the system by the Dean-stark trap. After the heating under reflux was continued for 3 hours and generation of water was scarcely recognized, toluene was taken out of the system by the Dean-stark trap. The reaction temperature was raised gradually to 200° C. and stirring was continued for 3 hours, followed by the addition of 16.7 g (97 mmol) of 2,6-dichlrobenzonitrile. The reaction was continued for further 5 hours.

After the reaction mixture was allowed to cool, 100 ml of toluene was added to dilute the reaction mixture therewith. An inorganic salt insoluble in the reaction mixture was filtered and the filtrate was poured into 2 liter of methanol to cause precipitation. The precipitate thus obtained was filtered, dried and then dissolved in 250 ml of THF. The resulting solution was poured into 2 liter of methanol to cause re-precipitation. The white powder thus precipitated was filtered and dried, whereby 1189 g of the target compound was obtained.

The number-average molecular weight (Mn) by GPC of the resulting compound was 7,300. It was confirmed by ¹H-NMR spectrum that the compound thus obtained was an oligomer represented by the following formula (III):

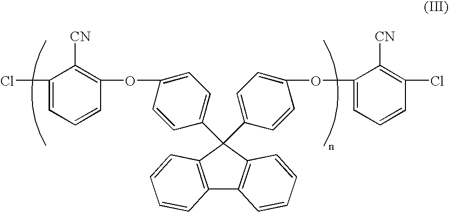

Next, in a 1-L three-necked 1-L flask equipped with a stirrer, thermometer and nitrogen inlet tube, 207.5 g (517 mmol) of neopentyl 3-(2,5-dichlorobenzoyl)benzenesulfonate, 57.7 g (7.88 mmol) of the oligomer of the formula (III) having Mn of 7,300, 10.3 g (15.8 mmol) of bis(triphenylphosphine)nickel dichloride, 2.36 g (15.8 mmol) of sodium iodide, 55.1 g (210 mmol) of triphenylphosphine and 82.4 g (1260 mmol) of zinc were weighed, followed by purging with dry nitrogen. Then, 720 ml of N,N-dimethylacetamide (DMAc) was added. Stirring was continued for 3 hours while maintaining the reaction temperature at 80° C. The reaction mixture was diluted with 1360 ml of DMAc and an insoluble matter was filtered.

The resulting solution was charged in a 2-L three-necked 2-L flask equipped with a stirrer, thermometer and nitrogen inlet tube. After heating to 115° C., the solution was stirred and 99.8 g (1140 mmol) of lithium bromide was added. After stirring for 7 hours, the reaction mixture was poured into 5 liter of acetone to cause precipitation. The precipitate thus obtained was washed successively with 1M hydrochloric acid and pure water, followed by drying, whereby 223 g of the target polymer was obtained.

The weight average molecular weight (Mw) by GPC of the resulting polymer was 142,000. It was presumed by ¹H-NMR spectrum that the polymer was a sulfonated polymer represented by the following formula (IV):

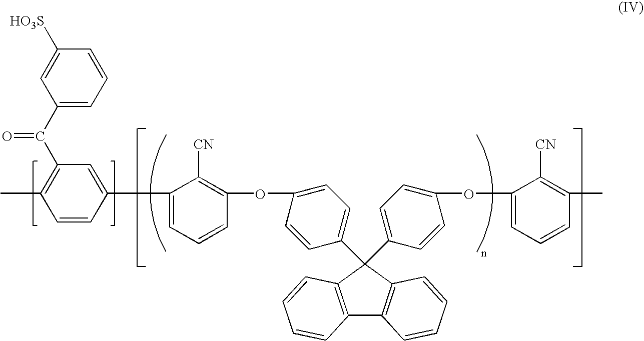

Next, in a similar manner to Example 1 except for the use of the sulfonated polymer obtained in this Example, a membrane-electrode assembly was prepared.

Next, physical properties of the sulfonated polymer, polymer electrolyte membrane and membrane-electrode assembly obtained in this Example, and power generation properties of the membrane-electrode assembly were rated in exactly the same manner as in Example 1. The results are shown in Table 1.

### EXAMPLE 4

In a 1-L three-necked flask equipped with a stirrer, thermometer, Dean-stark trap, nitrogen inlet tube and condenser tube, 24.1 g (71.7 mmol) of 2,2-bis(4-hydroxyphenyl)-1,1,1,3,3,3-hexafluoropropane, 10.1 g (28.7 mmol) of 9,9-bis(4-hydroxyphenyl)-fluorene, 19.7 g (115 mmol) of 2,6-dichlorobenzonitrile and 18.0 g (130 mmol) of potassium carbonate were weighed. After purging with nitrogen, 135 ml of sulfolane and 67 ml of toluene were added and the resulting mixture was stirred. The reaction mixture was then heated under reflux over an oil bath at 150° C. Water produced by the reaction was taken out of the system by the Dean-stark trap. After the heating under reflux was continued for 3 hours and generation of water was scarcely recognized, toluene was taken out of the system by the Dean-stark trap. The reaction temperature was raised gradually to 200° C. and stirring was continued for 5 hours, followed by the addition of 9.86 g (57.3 mmol) of 2,6-dichlorobenzonitrile. The reaction was continued for further 3 hours.

After the reaction mixture was allowed to cool, 100 ml of toluene was added to dilute the reaction mixture therewith. An inorganic salt insoluble in the reaction mixture was filtered and the filtrate was poured into 2 liter of methanol to cause precipitation. The precipitate thus obtained was filtered, dried and then dissolved in 250 ml of THF. The resulting solution was poured into 2 liter of methanol to cause re-precipitation. The white powder thus precipitated was filtered and dried, whereby 40.1 g of the target compound was obtained.

The number-average molecular weight (Mn) by GPC of the resulting compound was 7,400. It was confirmed by ¹H-NMR spectrum that the compound thus obtained was an oligomer represented by the below-described formula (V). In the below-described formula (V), a ratio (a:b) of recurrence frequency (a) to recurrence frequency (b) was 71:29. In this specification, the structure unit indicated by the recurrence frequency (a) is called “first structure”, while the structure unit indicated by the recurrence frequency (b) is called “second structure”.

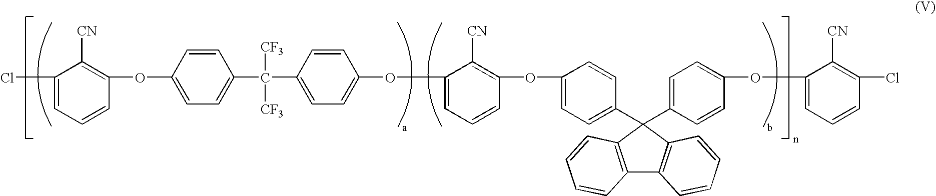

Next, in a 1-L three-necked flask equipped with a stirrer, thermometer and nitrogen inlet tube, 119 g (296 mmol) of neopentyl 3-(2,5-dichlorobenzoyl)benzenesulfonate, 31.1 g (4.2 mmol) of the oligomer of the formula (V) having Mn of 7,400, 5.89 g (9.0 mmol) of bis(triphenylphosphine)nickel dichloride, 1.35 g (9.0 mmol) of sodium iodide, 31.5 g (120 mmol) of triphenylphosphine and 47.1 g (720 mmol) of zinc were weighed, followed by purging with dry nitrogen. Then, 350 ml of N,N-dimethylacetamide (DMAc) was added. Stirring was continued for 3 hours while maintaining the reaction temperature at 80° C. The reaction mixture was diluted with 700 ml of DMAc and an insoluble matter was filtered out.

The resulting solution was charged in a 2-L three-necked 2-L flask equipped with a stirrer, thermometer and nitrogen inlet tube. After heating to 115° C. and stirring, 56.5 g (651 mmol) of lithium bromide was added. The mixture was stirred for 7 hours and then, the reaction mixture was poured into 5 liter of acetone to cause precipitation. The precipitate thus obtained was washed successively with 1M hydrochloric acid and pure water, followed by drying, whereby 102 g of the target polymer was obtained.

The weight average molecular weight (Mw) by GPC of the resulting polymer was 160,000. It was presumed by ¹H-NMR spectrum that the polymer was a sulfonated polymer represented by the following formula (VI):

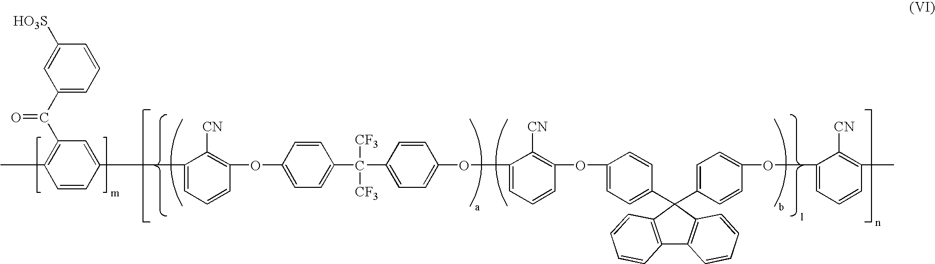

Next, in a similar manner to Example 1 except for the use of the sulfonated polymer obtained in this Example, a membrane-electrode assembly was prepared.

Next, physical properties of the sulfonated polymer, polymer electrolyte membrane and membrane-electrode assembly obtained in this Example, and power generation properties of the membrane-electrode assembly were rated in exactly the same manner as in Example 1. The results are shown in Table 1.

### EXAMPLE 5

In a 1-L three-necked flask equipped with a stirrer, thermometer, Dean-stark trap, nitrogen inlet tube and condenser tube, 27.8 g (82.9 mmol) of 2,2-bis(4-hydroxyphenyl)-1,1,1,3,3,3-hexafluoropropane, 3.08 g (16.5 mmol) of 4,4′-biphenol, 19.9 g (116 mmol) of 2,6-dichlorobenzonitrile and 17.8 g (129 mmol) of potassium carbonate were weighed. After purging with nitrogen, 130 ml of sulfolane and 63 ml of toluene were added and the resulting mixture was stirred. The reaction mixture was then heated under reflux over an oil bath at 150° C. Water produced by the reaction was taken out of the system by the Dean-stark trap. After the heating under reflux was continued for 3 hours and generation of water was scarcely recognized, toluene was taken out of the system by the Dean-stark trap. The reaction temperature was raised gradually to 200° C. and stirring was continued for 5 hours, followed by the addition of 11.4 g (66.2 mmol) of 2,6-dichlorobenzonitrile. The reaction was continued for further 3 hours.

After the reaction mixture was allowed to cool, it was diluted with 100 ml of toluene. An inorganic salt insoluble in the reaction mixture was filtered and the filtrate was poured into 2 liter of methanol to cause precipitation. The precipitate thus obtained was filtered, dried and then dissolved in 250 ml of THF. The resulting solution was poured into 2 liter of methanol to cause re-precipitation. The white powder thus precipitated was filtered and dried, whereby 39.2 g of the target compound was obtained.

The number-average molecular weight (Mn) by GPC of the resulting compound was 6,000. It was confirmed by ¹H-NMR spectrum that the compound thus obtained was an oligomer represented by the below-described formula (VII). In the formula (VII), a ratio (a:b) of recurrence frequency (a) to the recurrence frequency (b) was 83:17.

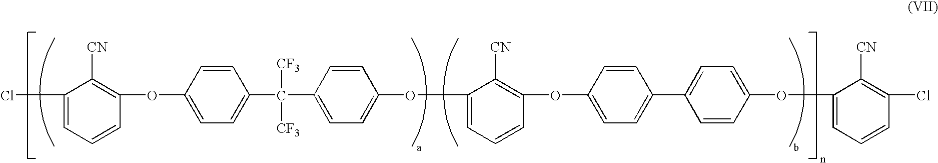

Next, in a 1-L three-necked flask equipped with a stirrer, thermometer and nitrogen inlet tube, 118 g (295 mmol) of neopentyl 3-(2,5-dichlorobenzoyl)benzenesulfonate, 31.5 g (5.3 mmol) of the oligomer of the formula (VII) having Mn of 6,000, 5.89 g (9.0 mmol) of bis(triphenylphosphine)nickel dichloride, 1.35 g (9.0 mmol) of sodium iodide, 31.5 g (120 mmol) of triphenylphosphine and 47.1 g (720 mmol) of zinc were weighed, followed by purging with dry nitrogen. Then, 350 ml of N,N-dimethylacetamide (DMAc) was added. Stirring was continued for 3 hours while maintaining the reaction temperature at 80° C. The reaction mixture was diluted with 700 ml of DMAc and an insoluble matter was filtered out.

The resulting solution was charged in a 2-L three-necked flask equipped with a stirrer, thermometer and nitrogen inlet tube. After the solution was heated to 115° C. and stirred, 56.3 g (64.8 mmol) of lithium bromide was added thereto. After stirring for 7 hours, the reaction mixture was poured into 5 liter of acetone to cause precipitation. The precipitate thus obtained was washed successively with 1M hydrochloric acid and pure water, followed by drying, whereby 101 g of the target polymer was obtained.

The weight average molecular weight (Mw) by GPC of the resulting polymer was 165,000. It was presumed by ¹H-NMR spectrum that the polymer was a sulfonated polymer represented by the following formula (VIII):

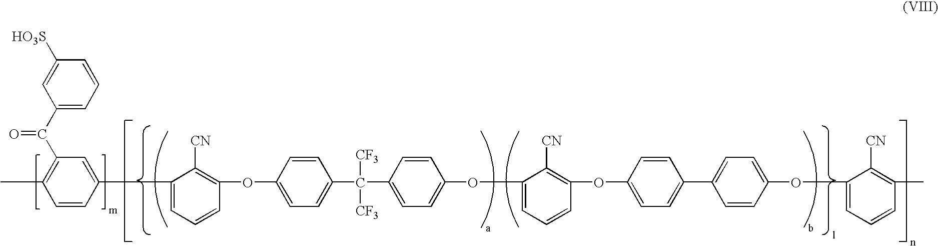

Next, in a similar manner to Example 1 except for the use of the sulfonated polymer obtained in this Example, a membrane-electrode assembly was prepared.

Next, physical properties of the sulfonated polymer, polymer electrolyte membrane and membrane-electrode assembly obtained in this Example, and power generation properties of the membrane-electrode assembly were rated in exactly the same manner as in Example 1. The results are shown in Table 1.

### COMPARATIVE EXAMPLE 1

In a 1-L three-necked 1-L flask equipped with a stirrer, thermometer, Dean-stark trap and nitrogen inlet tube, 67.3 g (0.20 mol) of 2,2-bis(4-hydroxyphenyl)-1,1,1,3,3,3-hexafluoropropane, 60.3 g (0.24 mol) of 4,4′-dichlorobenzophenone and 71.9 g (0.52 mol) of potassium carbonate were weighed. After purging with nitrogen, 300 ml of N,N-dimethylacetamide (DMAc) and 150 ml of toluene were added and the resulting mixture was stirred. The reaction mixture was then heated under reflux over at 130° C. an oil bath. Water produced by the reaction was azeotroped with toluene and taken out of the system by the Dean-stark trap. After the heating under reflux was continued for 3 hours and generation of water was scarcely recognized, the reaction temperature was raised gradually from 130° C. to 150° C. and most of toluene was taken out of the system by the Dean-stark trap. The reaction was then continued at 150° C. for 10 hours, followed by the addition of 10.0 g (0.040 mol) of 4,4′-dichlorobenzophenone. The reaction was continued for further 5 hours.

After the reaction mixture was allowed to cool, an inorganic salt insoluble in the reaction mixture was filtered and the filtrate was poured into 4 liter of methanol to cause precipitation. The precipitate thus obtained was filtered, dried and then dissolved in 300 ml of THF. The resulting solution was poured into 4 liter of methanol to cause re-precipitation, whereby 95 g of the target compound was obtained.

The number-average molecular weight (Mn) by GPC of the resulting compound was 11,200. It was found that the compound thus obtained was an oligomer represented by the below-described formula (IX).

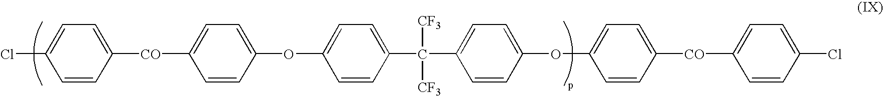

Next, in a 1-L three-necked flask equipped with a stirrer, thermometer and nitrogen inlet tube, 39.58 g (98.64 mmol) of neopentyl 4-[4-(2,5-dichlorobenzoyl)phenoxy]benzenesulfonate, 15.23 g (1.36 mmol) of the oligomer of the formula (IX) having Mn of 11,200, 1.67 g (2.55 mmol) of bis(triphenylphosphine)nickel dichloride, 0.45 g (3.0 mmol) of sodium iodide, 10.49 g (40 mmol) of triphenylphosphine and 15.69 g (240 mmol) of zinc were weighed, followed by purging with dry nitrogen. Then, 390 ml of NMP was added. Stirring was continued for 3 hours while maintaining the reaction temperature at 75° C. The reaction mixture after polymerization was diluted with 250 ml of THF. After stirring for 30 minutes, the reaction mixture was filtered through celite used as a filtering aid. The filtrate was poured into 1500 ml of methanol to cause coagulation. The coagulated substances were collected by filtration and air dried, and then re-dissolved in a mixed solvent composed of 200 ml of THF and 300 ml of NMP. The resulting solution was poured into 1500 ml of methanol to cause coagulation and precipitation. The resulting precipitate was air dried and then heat dried to yield 47.0 g of a copolymer containing a target sulfonic acid derivative protected with a neopentyl group as yellow fibrous crystals. It was found that the number average molecular weight (Mn) and weight average molecular weight (Mw) by GPC of the resulting copolymer were 47,600 and 159,000, respectively.

Next, in 60 ml of NMP was dissolved 5.1 g of the resulting copolymer and the resulting solution was heated to 90° C. To the resulting solution was added a mixture of 50 ml of methanol and 8 ml of concentrated hydrochloric acid at once to suspend the copolymer in the solution. The resulting suspension was reacted for 10 hours under mild reflux conditions. A distilling apparatus was installed and excess methanol was distilled off to yield a pale green clear solution. The resulting solution was poured into a large amount of a solvent obtained by mixing water and methanol at a weight ratio of 1:1 to solidify the copolymer. The copolymer was then washed with ion exchange water until the pH of the wash liquid became 6 or greater. It was confirmed by IR spectrum and quantitative analysis of ion exchange capacity, the neopentyl sulfonate group of the copolymer was converted into a sulfonic acid group (—SO₃H) quantitatively.

With regard to the molecular weight by GPC of the resulting copolymer, Mn was 53,200 and Mw was 185,000. The sulfonic acid equivalent of the resulting copolymer was 1.9 meq/g.

It was presumed that the copolymer thus obtained was a sulfonated polymer represented by the following formula (X):

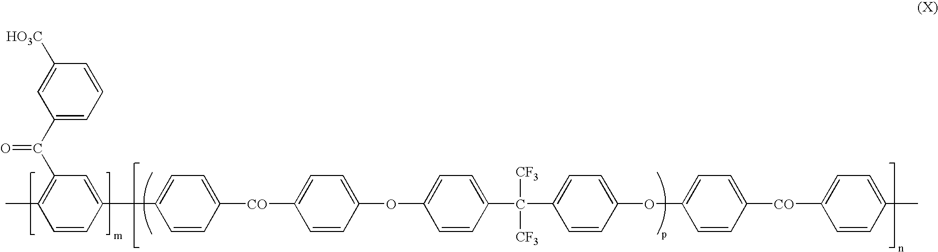

Next, a film of 40 μm thick was obtained by casting a 10 wt % NMP solution of the sulfonated polymer obtained in this Comparative Example on a glass plate.

Next, in a similar manner to Example 1 except for the use of the above-described film obtained in this Comparative Example, a membrane-electrode assembly was prepared.

Next, the physical properties of the sulfonated polymer, polymer electrolyte membrane and membrane-electrode assembly obtained in this Comparative Example, and power generation properties of the membrane-electrode assembly were rated in exactly the same manner as in Example 1. The results are shown in Table 1.

TABLE 1

| | | | | | | | Comp. |
|---|---|---|---|---|---|---|---|
| | | Examples | | | | | Ex. |
| | | 1 | 2 | 3 | 4 | 5 | 1 |
| Ion exchange capacity (meq/g) | | 2.4 | 2.5 | 2.5 | 2.6 | 2.6 | 1.9 |
| Composition | First structure | 100 | 100 | — | 71 | 83 | — |
| ratio | Second structure | — | — | 100 | 29 | 17 | — |
| Proton conductivity (S/cm) | | 0.31 | 0.37 | 0.36 | 0.41 | 0.43 | 0.27 |
| Hot water | Weight retention (%) | 100 | 100 | 100 | 100 | 100 | 90 |
| resistance | Size change (%) | 120 | 122 | 127 | 120 | 124 | 130 |

| | | | | | | |
|---|---|---|---|---|---|---|
| Fenton's reagent resistance (%) | 100 | 100 | 95 | 99 | 97 | 80 |
| Electrode adhesion (%) | 99 | 95 | 95 | 99 | 97 | 59 |
| Power generation performance (V) | 0.653 | 0.650 | 0.658 | 0.661 | 0.659 | 0.643 |
| Power generation durability (hour) | 530 | 495 | 380 | 420 | 398 | 260 |
| Low-temperature durability | Good | Good | Good | Good | Good | Poor |

From Table 1, it has been elucidated that compared with the sulfonated polyarylene polymer obtained in Comparative Example 1, the sulfonated polyarylene polymers used for the membrane electrode assemblies of Examples 1 to 5 have excellent ion exchange capacity.

Also, from Table 1, it has also been elucidated that compared with the membrane-electrode assembly obtained in Comparative Example 1, the membrane electrode assemblies obtained in Examples 1 to 5 have excellent proton conductivity, hot water resistance, acid resistance, electrode adhesion and power generation performance and they can maintain their power generation performance for a long period of time even under low temperature environment.

1. A membrane-electrode assembly for a solid polymer electrolyte fuel cell comprising a pair of electrode catalyst layers containing a catalyst; and
a polymer electrolyte membrane inserted between the two electrode catalyst layers, wherein:
the polymer electrolyte membrane comprises a sulfonated polyarylene polymer having a first recurring unit represented by the formula (1) and a second unit represented by the formula (2) 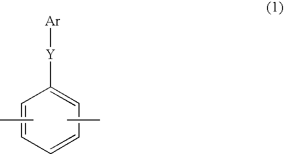
(wherein Y represents a divalent atom or organic group, or a direct bond, and Ar represents an aromatic group, with the proviso that the aromatic group includes derivatives thereof) 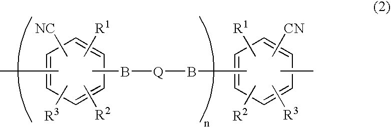
(wherein B independently represents an oxygen atom or a sulfur atom, R¹ to R³ each represents a hydrogen atom, a fluorine atom, a nitrile group or an alkyl group and they may be the same or different, n stands for an integer of 2 or greater and Q is a structure represented by the following formula (3): 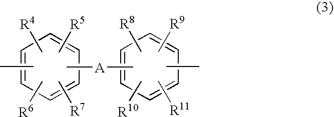
(wherein A independently represents a divalent atom or organic group, or a direct bond, and R⁴ to R¹¹ each represents a hydrogen atom, a fluorine atom, an alkyl group or an aromatic group and they may be the same or different, with the proviso that the aromatic group includes derivatives thereof)).

2. A membrane-electrode assembly for the solid polymer electrolyte fuel cell according to claim 1, wherein the structure represented by the formula (3) includes, as the A, at least one organic group selected from the class consisting of —CONH—, —(CF₂)ₚ— (in which p is an integer of from 1 to 10), —C (CF₃)₂—, —COO—, —SO—, —SO₂— and organic groups represented by the following formula (4): 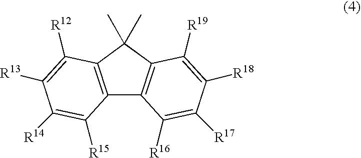
(wherein R¹² to R¹⁹ each represents a hydrogen atom, a fluorine atom, an alkyl group or an aromatic group and they may be the same or different with the proviso that the aromatic group includes derivatives thereof).

3. A membrane-electrode assembly for the solid polymer electrolyte fuel cell according to claim 1, wherein the structure represented by the formula (3) contains a first structure in which the A is an organic group selected from the class consisting of —CONH—, —(CF₂)ₚ— (in which p is an integer of from 1 to 10), —C(CF₃)₂—, —COO—, —SO— and —SO₂— and a second structure in which the A represents a direct bond or an organic group represented by the following formula (4): 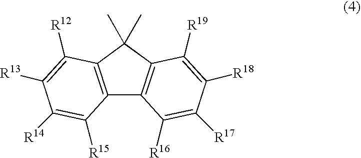
(wherein R¹² to R¹⁹ each represents a hydrogen atom, a fluorine atom, an alkyl group or an aromatic group and they may be the same or different with the proviso that the aromatic group includes derivatives thereof).

4. A membrane-electrode assembly for the solid polymer electrolyte fuel cell according to claim 3, wherein the structure represented by the formula (3) comprises from 70 to 99 mol % of the first structure and from 1 to 30 mol % of the second structure (with the proviso that the total of the first and second structures is adjusted to 100 mol %).

5. A membrane-electrode assembly for the solid polymer electrolyte fuel cell according to claim 1, wherein the electrode catalyst layer includes carbon particles having a catalyst supported thereon and an ion conductive binder composed of a perfluoroalkylenesulfonic acid polymer compound and contains from 0.01 to 1.0 mg/cm² of platinum as the catalyst.

6. A solid polymer electrolyte fuel cell comprising a membrane-electrode assembly for a solid polymer electrolyte fuel cell including a pair of electrode catalyst layers containing a catalyst; and
a polymer electrolyte membrane inserted between the two electrode catalyst layers, wherein:
the polymer electrolyte membrane being composed of a sulfonated polyarylene polymer having a first recurring unit represented by the formula (1) and a second unit represented by the formula (2): 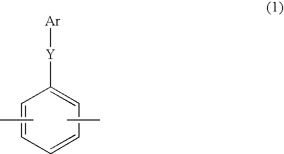
(wherein Y represents a divalent atom or organic group, or a direct bond, and Ar represents an aromatic group, with the proviso that the aromatic group includes derivatives thereof) 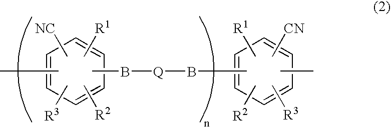
(wherein B independently represents an oxygen atom or a sulfur atom, R¹ to R³ each represents a hydrogen atom, a fluorine atom, a nitrile group or an alkyl group and they may be the same or different, n stands for an integer of 2 or greater and Q is a structure represented by the following formula (3): 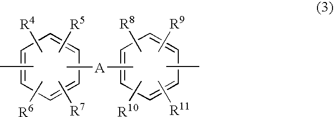
(wherein A independently represents a divalent atom or organic group, or a direct bond, and R⁴ to R¹¹ each represents a hydrogen atom, a fluorine atom, an alkyl group or an aromatic group and they may be the same or different, with the proviso that the aromatic group includes derivatives thereof).
